(19) United States
(12) Patent Application Publication
(10) Pub. No.: US 2019/0380512 A1
(43) Pub. Date: Dec. 19, 2019

(54) MAGNETIC DISPLAY UNIT AND METHOD

(71) Applicant: Chad Murawczyk, George Town (GB)

(72) Inventors: Chad Murawczyk, George Town (GB); Matthew Riva, New York, NY (US)

(21) Appl. No.: 16/478,878

(22) PCT Filed: Jan. 30, 2017
(86) PCT No.: PCT/US17/15549

§ 371 Date: Jul. 18, 2019

(51) Int. Cl. A47F 1/08; A47F 7/28; G09F 5/04; G09F 7/04; H01F 7/02

(52) U.S. Cl. CPC A47F 1/08; A47F 7/28; G09F 2005/046; G09F 7/04; H01F 7/0252; G09F 5/04

(57) ABSTRACT

A display unit of the present invention includes: a base; and an arm extending from the base, the arm having an end portion for removably retaining a dispenser of material vertically above a surface; wherein the end portion and the dispenser are magnetically coupled in a removable retained configuration. The dispenser is associated with a cap; wherein the cap includes a first magnetically-sensitive member, and the cap is fixed to a bottom portion of the end portion; and wherein the dispenser includes a second magnetically-sensitive member which is magnetically coupled and removably attached to the first magnetically-sensitive member. The second magnetically-sensitive member is composed of a permanent magnet. In an alternative embodiment, the dispenser includes: a container of the material; an outlet connected to the container; and a collar mounted to at least one of the container or the outlet, with the collar including the second magnetically-sensitive member.

### BACKGROUND OF THE INVENTION

### 1. Field of the Invention

The present invention relates to a display devices, and in particular to a display unit and method which utilize magnets to facilitate the display of dispensers.

### 2. Description of Prior Art

Dispensers are used to control the output of material from a container. For example, skincare, haircare, make-up coloring, fragrances, and toiletries are often performed by dispensing liquids from a container using a spray or pump. Other fields such as lubricants in auto parts stores, medications in drug stores and dispensaries in pharmacies, and food materials such as cake icing and condiments in food preparation also utilize dispensers in the form of a spray or pump.

In the sale of such materials and their dispensers, such as perfumes and lotions, consumers and other users often view such dispensers in a countertop display unit, with dispensers labeled and arranged in and/or upon a perfume counter, and consumers often select and lift up dispensers to sample the material, such as by spraying a small amount of perfume to inhale or lotion on one's skin, which encourages sales of the perfume or lotion.

However, the consumer sampling a perfume or lotion may be required to use both hands initially to remove a cap from the dispenser, and the consumer then must hold or put down the cap prior to sampling from the dispenser, and further the consumer must restore the cap to the dispenser when the consumer has completed the sampling process. Such handling of the dispenser cap is both inconvenient and inefficient.

In addition, as consumers lift the dispensers from a display counter for sampling, the consumer often returns the dispenser back to the countertop when sampling has completed. However, consumers may haphazardly place the dispenser back on the countertop, requiring a store clerk to continually reorganize the dispensers after each consumer interaction in order to present the dispensers in an aesthetic arrangement for future consumers to sample and purchase.

A need exists for a display unit, system, and method which conveniently provides dispensers to consumers without their handling of the dispenser caps and which encourages the reorganization of the dispensers in an organized display.

### OBJECTS AND SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present invention solves the problems of the prior art and provides additional advantages which are described in more detail below.

A display unit of the present invention includes: a base; and an arm extending from the base, the arm having an end portion for removably retaining a dispenser of material vertically above a surface; wherein the end portion and the dispenser are magnetically coupled in a removable retained configuration. The dispenser is associated with a cap; wherein the cap includes a first magnetically-sensitive member, and the cap is fixed to a bottom portion of the end portion; and wherein the dispenser includes a second magnetically-sensitive member which is magnetically coupled and removably attached to the first magnetically-sensitive member. The second magnetically-sensitive member is composed of a permanent magnet.

In an alternative embodiment, the dispenser includes: a container of the material; a pump connected to the container; and a collar mounted to at least one of the container or the pump, with the collar including the second magnetically-sensitive member. In another embodiment, the first magnetically-sensitive member is an activatable electromagnet. In a further embodiment, the cap is removably fixed to the end portion by a friction-fit, or by at least one detent. In another embodiment, end portion includes a first magnetically-sensitive member, and the dispenser includes a second magnetically-sensitive member which is magnetically coupled and removably attached to the first magnetically-sensitive member.

A display system of the present invention includes: a base; and a plurality of arms extending from the base, each arm having an end portion for removably retaining a respective dispenser of material vertically above a surface; wherein each end portion and any associated removably retained dispenser are magnetically coupled in a removable retained configuration. Each dispenser is associated with a cap; wherein each cap includes a first magnetically-sensitive member, and the cap is fixed to a bottom portion of a respective end portion; and wherein the dispenser includes a second magnetically-sensitive member which is magnetically coupled and removably attached to the first magnetically-sensitive member. In one embodiment, the second magnetically-sensitive member is composed of a permanent magnet. In an alternative embodiment, each dispenser includes: a container of the material; a pump connected to the container; and a collar mounted to at least one of the container or the pump, with the collar including the second magnetically-sensitive member. In another alternative embodiment, each cap is removably fixed to its respective end portion by a friction-fit or by at least one detent. In another alternative embodiment, each end portion includes a first magnetically-sensitive member; and wherein any dispenser associated with a respective end portion includes a second magnetically-sensitive member which is magnetically coupled and removably attached to a respective first magnetically-sensitive member.

A method of the present invention includes extending an arm from a base, the arm having an end portion; removably retaining, by the end portion, a dispenser of material vertically above a surface; and wherein the end portion and the dispenser are magnetically coupled in a removable retained configuration. The method further includes fixing a cap to a bottom portion of the end portion; and associating the dispenser with the cap; wherein the cap includes a first magnetically-sensitive member; and wherein the dispenser includes a second magnetically-sensitive member which is magnetically coupled and removably attached to the first magnetically-sensitive member. The second magnetically-sensitive member is composed of a permanent magnet. In an alternative embodiment, the method includes removably fixing the cap to the end portion by at least one detent. In a further alternative embodiment, wherein the end portion includes a first magnetically-sensitive member; and wherein the dispenser includes a second magnetically-sensitive member which is magnetically coupled and removably attached to the first magnetically-sensitive member.

### BRIEF DESCRIPTION OF THE DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a top side perspective view of a first embodiment of the display unit of the present invention;

FIG. 2 is a top side perspective view of a second embodiment of the display unit of the present invention;

FIG. 3 is a top side perspective view of a third embodiment of the display unit of the present invention;

FIG. 4 is a top side perspective view of a fourth embodiment of the display unit of the present invention;

FIG. 5 is a top side perspective view of a dispenser of the present invention;

FIG. 6 is a top side perspective view of a first embodiment of the dispenser of FIG. 5 with parts separated;

FIG. 7 is a top side perspective view of a second embodiment of the dispenser of FIG. 5 with parts separated;

FIG. 8 is a top side perspective view of an end portion of the display unit of the present invention retaining the dispenser with a cap;

FIG. 9 is a bottom plan view of the end portion of the display unit of the present invention retaining a cap of FIG. 8;

FIG. 10 is a top side perspective view of an alternative embodiment of the end portion of the display unit of the present invention retaining a dispenser without a cap; and

FIG. 11 is a bottom plan view of the alternative embodiment of the end portion of the display unit of the present invention of FIG. 10.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION OF THE INVENTION

Certain terminology is used in the following description for convenience only and is not limiting. The article “a” is intended to include one or more items, and where only one item is intended the term “one” or similar language is used. Additionally, to assist in the description of the present invention, words such as top, bottom, upper, lower, front, rear, inner, outer, right and left are used to describe the accompanying figures. The terminology includes the words above specifically mentioned, derivatives thereof, and words of similar import.

FIG. 1 is a top side perspective view of a first embodiment of the display unit 10 of the present invention, in which a dispenser 12, which contains material therein, is removably retained vertically above a surface or the floor by a magnetic coupling configuration. The display unit 10 includes a base 14, a rib or arm 16, and an end portion 18 of the arm 16. As described herein, the dispenser 12 may be associated with a cap which is retained in the end portion 18, and the cap and the dispenser 12 have magnetically-sensitive members to establish the magnetic coupling, allowing the dispenser 12 to be retained over a surface or the floor. Once a consumer or user applies sufficient downward force on the dispenser 12 with one hand, the dispenser 12 and the cap in the end portion will separate, permitting the user to sample or output the material from the container. Accordingly, the user is not required to hold or grasp the cap in order to disengage the dispenser from the cap.

After the user has sampled or output the material, the user can return the dispenser 12 to the display unit 10 by bringing the top of the dispenser 12 under the end portion 18 to have the magnetically-sensitive members of the cap and the dispenser 12 to re-engage in the magnetically coupled configuration.

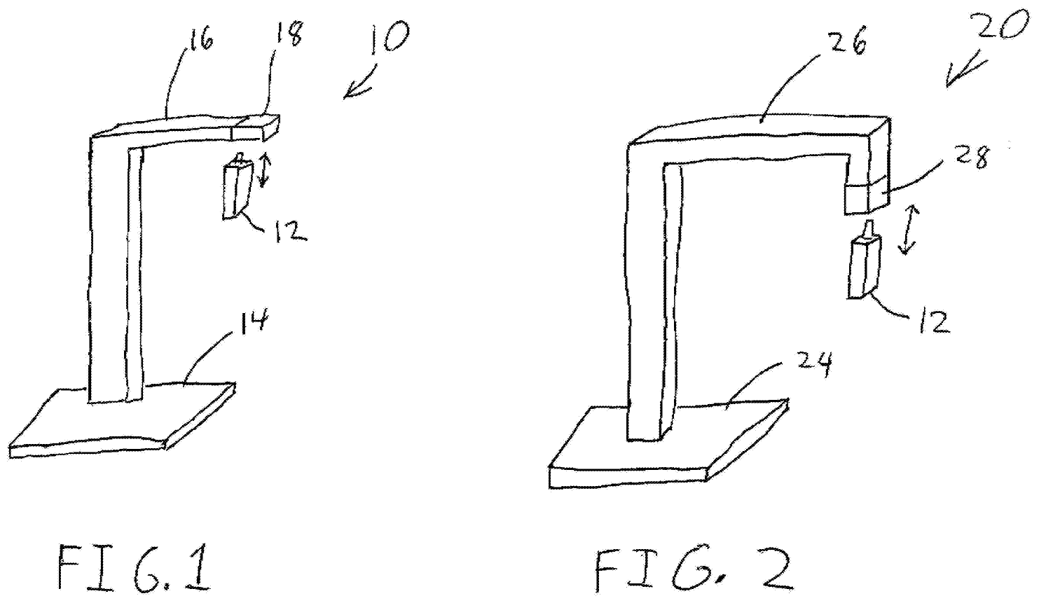

In the first embodiment, the end portion 18 extends horizontally from the arm 16, as shown in FIG. 1. In an alternative second embodiment, as shown in FIG. 2, the display unit 20 has a base 24, an L-shaped rib or arm 26, and an end portion 28 which extends vertically from the end of the arm 26. The end portions 18, 28 may also be composed of transparent and/or translucent material, allowing the end portions 18, 28 to be illuminated by electronics within at least the arms 16, 26, respectively, and optionally the bases 14, 24, respectively. Such electronics may also be used to power electromagnets, as described herein for alternative embodiments of the display units 10, 20.

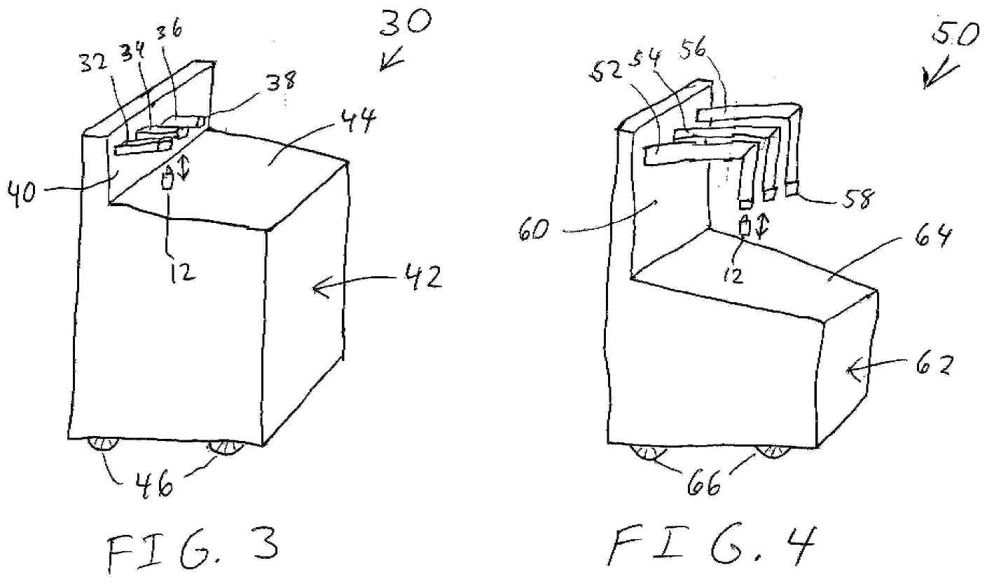

In a third embodiment shown in FIG. 3, the display unit 30 or system provides multiple ribs or arms 32, 34, 36 having end portions 38 extending horizontally from a back portion 40 of a display counter 42 of the display unit 30 or system. Each of the arms 32, 34, 36 is capable of magnetically holding respective dispensers 12 in a removable configuration vertically over a surface, such as a countertop 44 which is substantially horizontal or otherwise angularly oriented on the display counter 42. The display counter 42 may also include wheels 46 movable on a floor for positioning the display unit 30 in various locations and orientations for access by users.

In an alternative fourth embodiment shown in FIG. 4, the display unit 50 or system provides multiple ribs or arms 52, 54, 56 having an L-shape extending from a back portion 60 of a counter 62, and with end portions 58 extending vertically from the end of each respective arm. Each of the arms 52, 54, 56 is capable of magnetically holding respective dispensers 12 in a removable configuration vertically over a surface, such as a countertop 64 which is substantially horizontal or otherwise angularly oriented on the display counter 62. The display counter 62 may also include wheels 66 movable on a floor for positioning the display unit 60 in various locations and orientations for access by users. As with the embodiments in FIGS. 1-2, the display units 30, 50 may have end portions 38, 58 composed of transparent and/or translucent material, allowing the end portions 38, 58 to be illuminated by electronics within at least the arms 32, 34, 36, 52, 54, 56, respectively.

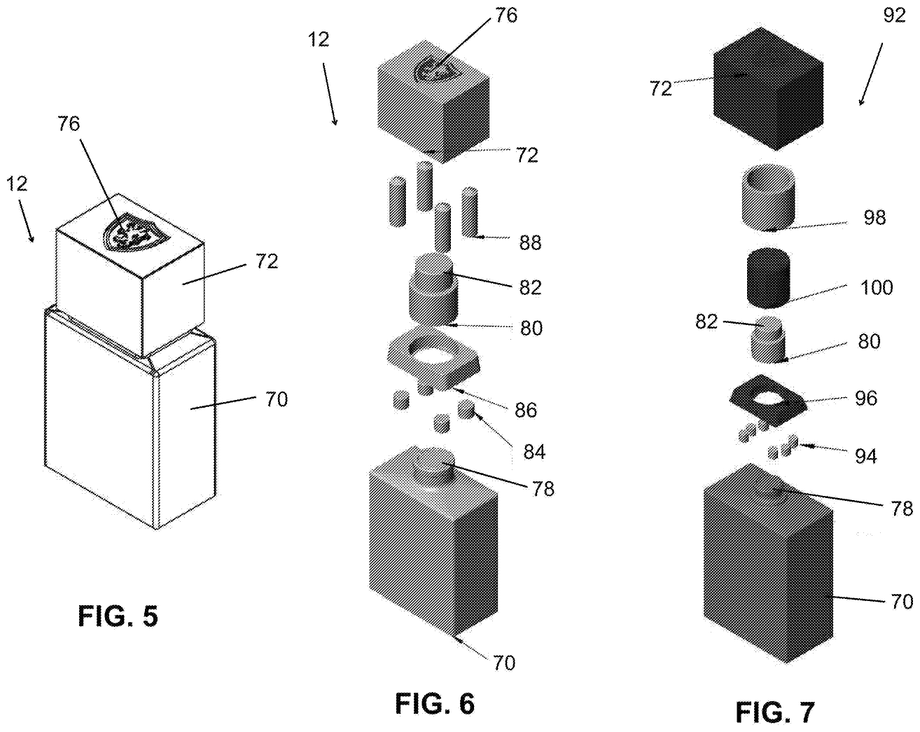

FIG. 5 is a top side perspective view of a dispenser 12 of the present invention, which includes a container 70 of material to be dispensed, and the dispenser 12 optionally includes a cap 72 associated with the container 70. Indicia 76 may be included on the container 70 and/or the cap 72, which may be brand names and logos, labels, or other indicia for identifying or associating the material in the container 70 with the indicia 76.

FIG. 6 is a top side perspective view of a first embodiment of the dispenser 12 of FIG. 5 with parts separated, showing the components of the dispenser 12 of the present invention for use with the display units 10, 20, 30, 50 shown in FIGS. 1-4, respectively. The container 70 includes a neck 78 for receiving a pump cap 80, allowing a pump action in a manner known in the art for dispensing material from the container 70, such as by pumping, atomizing, or spraying the material through an aperture or outlet 82 in the pump cap 80. Alternatively, the aperture 82 could be stand alone without a pump and positioned on the neck 78, for dispensing materials by displacing the container 70 from an upright position to dispense materials through the aperture.

To establish the magnetic coupling between the cap 72 and the container 70, the cap 72 is secured in the end portions 18, 28, 38, 58, as described herein, and at least one magnetically-sensitive member 84 is retained in a collar 86 which is secured to the container 70, for example, by adhesives or by being secured between the pump cap 80 and the neck 78, with the pump cap 80 screwed onto the neck 78 by screw threads. In addition, at least one magnetically-sensitive member 88 such as a rod is mounted within the cap 72, such that proximity of the magnetically-sensitive members 84, 88 forms the removable magnetic coupling between the cap 72 and the container 70.

In a first embodiment, at least one of the magnetically-sensitive members 84, 88 is a permanent magnet, such as a relatively magnetically-strong neodymium magnet, and the other of the magnetically-sensitive members 84, 88 is composed of a ferromagnetic material such as iron. For example, the magnetically-sensitive members 84 may be permanent magnets mounted in the collar 86, and the magnetically-sensitive members 88 are iron rods mounted in the cap 72. Alternatively, the magnetically-sensitive members 84 may be iron disks mounted in the collar 86, and the magnetically-sensitive members 88 are permanent magnets mounted in the cap 72. In still a further alternative embodiment, the magnetically-sensitive members 84, 88 are all composed of ferromagnetic materials such as iron, and the end portions 18, 28, 38, 58 have electromagnets, as well as known electronics and a power source, which convey magnetic attractive force through the magnetically-sensitive members 88 in the cap 72 to attract the magnetically-sensitive members 84 in the collar 86. Accordingly, the cap 72 will be magnetically coupled to the collar 86 mounted on and/or secured to the container 70.

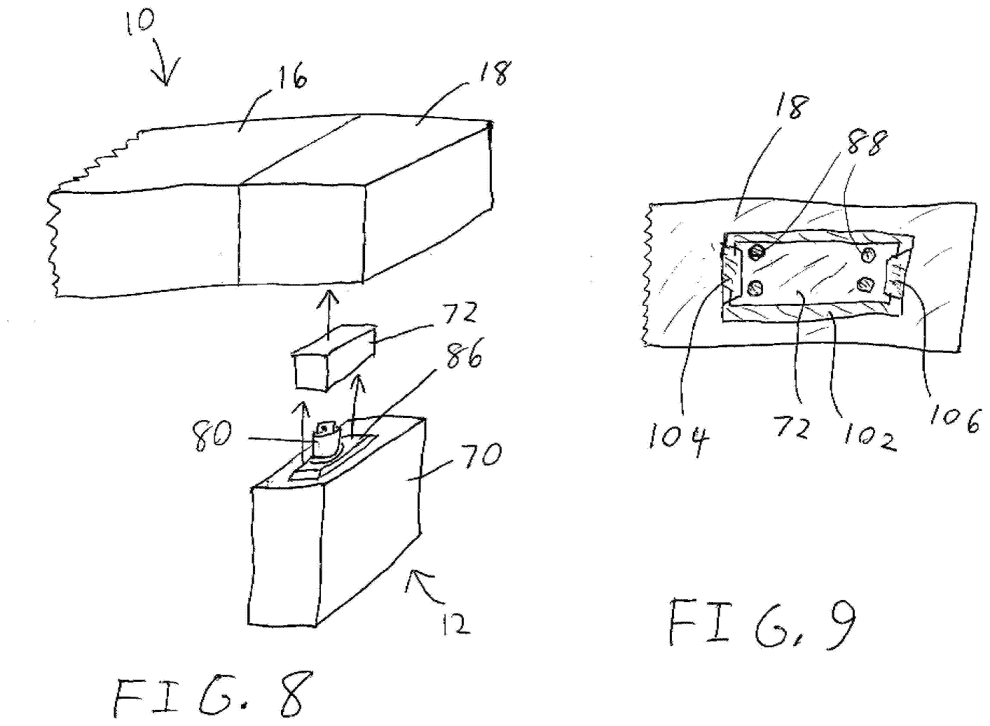

FIG. 7 is a top side perspective view of a second embodiment of the dispenser of FIG. 5 with parts separated, showing the components of the alternative dispenser 92 of the present invention for use with the display units 10, 20, 30, 50 shown in FIGS. 1-4, respectively. The container 70 includes a neck 78 for receiving a pump cap 80, allowing a pump action in a manner known in the art for dispensing material from the container 70, such as by pumping, atomizing, or spraying the material through an aperture 82 in the pump cap 80. Alternatively, the aperture 82 could be stand alone without a pump and positioned on the neck 78, for dispensing materials by displacing the container 70 from an upright position to dispense materials through the aperture.

To establish the magnetic coupling between the cap 72 and the container 70, the cap 72 is secured in the end portions 18, 28, 38, 58, as described herein, and at least one magnetically-sensitive member 94 is retained in a collar 96 which is secured to the container 70, for example, by adhesives or by being secured between the pump cap 80 and the neck 78, with the pump cap 80 screwed onto the neck 78 by screw threads. In addition, at least one magnetically-sensitive member 98 such as a ring is mounted within the cap 72 by surrounding an inner cap 100, such that proximity of the magnetically-sensitive members 94, 98 forms the removable magnetic coupling between the cap 72 and the container 70.

In a first embodiment, at least one of the magnetically-sensitive members 94, 98 is a permanent magnet, such as a relatively magnetically-strong neodymium magnet, and the other of the magnetically-sensitive members 94, 98 is composed of a ferromagnetic material such as iron. For example, the magnetically-sensitive members 94 may be permanent magnets mounted in the collar 96, and the magnetically-sensitive member 98 is an iron ring mounted about the inner cap 100 in the cap 72. Alternatively, the magnetically-sensitive members 94 may be iron disks mounted in the collar 96, and the magnetically-sensitive member 98 is a ring or annular-shaped permanent magnet mounted about the inner cap 100 in the cap 72. In still a further alternative embodiment, the magnetically-sensitive members 94, 98 are all composed of ferromagnetic materials such as iron, and the end portions 18, 28, 38, 58 have electromagnets, as well as known electronics and a power source, which convey magnetic attractive force through the magnetically-sensitive members 98 in the cap 72 to attract the magnetically-sensitive members 94 in the collar 96. Accordingly, the cap 72 will be magnetically coupled to the collar 96 mounted on and/or secured to the container 70.

Referring to FIGS. 1-4, the cap 72 is formed integral with the end portions 18, 28, 38, 58 of the respective ribs or arms 16, 26, 36, 56 of the display units 10, 20, 30, 50. That is, the inner portions of the ribs or arms 16, 26, 36, 56 are constructed of wood and fabricated to include the internal components of the cap 72 described above.

Alternatively, the cap 72 could be secured to the inner portions of the end portions 18, 28, 38, 58. FIG. 8 is a top side perspective view of an end portion of the display unit 10 of the present invention retaining the dispenser 12 with a cap 72, as shown in FIG. 6, and FIG. 9 is a bottom plan view of the end portion of the display unit 10 of the present invention retaining the cap 72. The cap 72 is secured within a cavity 102 in the end portion 18, for example, by a friction fit with the dimensions of the cap 72 being substantially complementary with the dimensions of the cavity 102. In an alternative embodiment, the end portion 18 includes at least one detent 104, 106 which secures the cap 72 within the cavity 102, so that the cap 72 is not required to have substantially complementary dimensions with the cavity 102. Alternatively, the cap 72 could be secured to the end portions 18, 28, 38, 58 by adhesive and/or fasteners.

With the cap 72 having the rods 88 and being secured within the cavity 102 of the end portion 18, the rods 88 magnetically attract the disks 84 in the collar 86, and so the cap 72 will be magnetically coupled to the collar 86 mounted on and/or secured to the container 70.

Accordingly, in the embodiments shown in FIGS. 8-9, the dispenser 12 with its container 70 will be removably magnetically secured to the underside of the end portion 18, allowing a user to remove the dispenser 12 with one hand, pump or spray the material using the pump 80, and then conveniently return the dispenser 12 to be magnetically secured to the underside of the end portion 18.

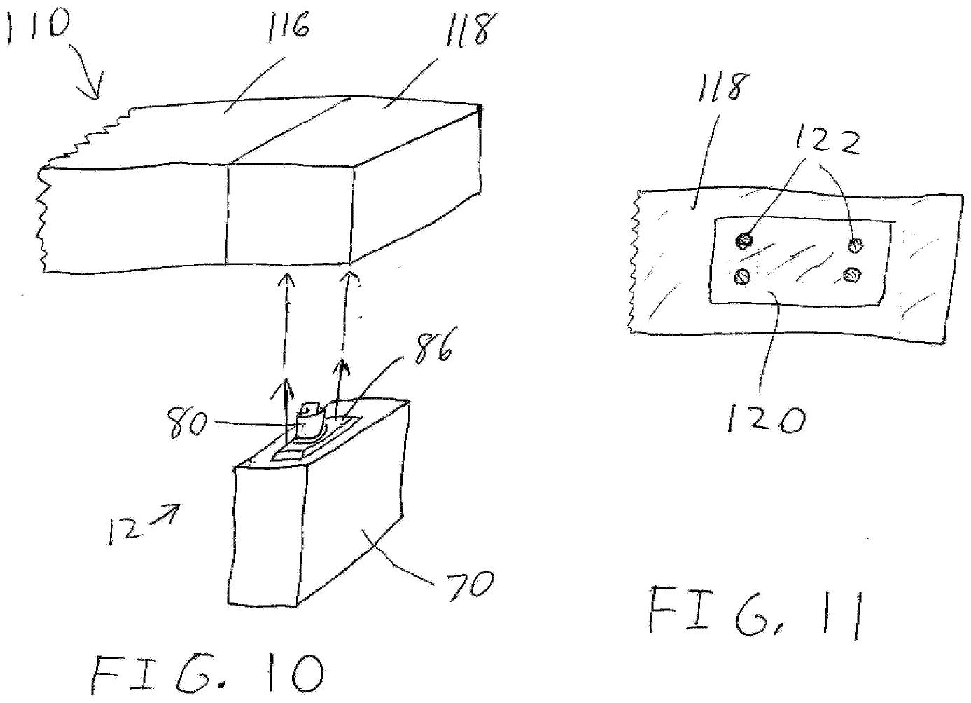

FIG. 10 is a top side perspective view of an alternative embodiment of the end portion 118 of the display unit 110 of the present invention retaining a dispenser 12 without a cap, and FIG. 11 is a bottom plan view of the alternative embodiment of the end portion 118 of the display unit of the present invention of FIG. 10. The end portion 118 extends, for example, horizontally from a rib or arm 116 of the display unit 110, or alternatively extends vertically, as in FIGS. 1-4. As shown in FIG. 11, the end portion 118 includes a cavity 120 for receiving the pump 80, and having at least one magnetically-sensitive member 122 for attracting the magnetically-sensitive members 84, 94 mounted in the collars 86, 96, as in FIGS. 6-7.

In a first embodiment, at least one of the magnetically-sensitive members 84, 122 is a permanent magnet, such as a relatively magnetically-strong neodymium magnet, and the other of the magnetically-sensitive members 84, 122 is composed of a ferromagnetic material such as iron. For example, the magnetically-sensitive members 84 may be permanent magnets mounted in the collar 86, and the magnetically-sensitive members 122 are iron rods mounted in the cavity 120 in FIG. 11. Alternatively, the magnetically-sensitive members 84 may be iron disks mounted in the collar 86, and the magnetically-sensitive members 122 are permanent magnets mounted in the cavity 120 in FIG. 11. In still a further alternative embodiment, the magnetically-sensitive members 84 are composed of ferromagnetic materials such as iron, and the at least one magnetically-sensitive member 122, such as rods in the end portions 118, are electromagnets, as well as known electronics and a power source, which convey magnetic attractive force through the magnetically-sensitive members 122 in the cavity 120 to attract the magnetically-sensitive members 84 in the collar 86. Accordingly, rods 122 will be magnetically coupled to the collar 86 mounted on and/or secured to the container 70.

The present invention could be applied to dispensers for a variety of products, with or without a pump mechanism. For example, products relating to skincare, hair care, cosmetics, fragrances, toiletries, food products and materials used in automobiles could be stored within dispensers for display at trade shows or retail stores, or for the purpose of storage and use at home.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A display unit comprising:
a base; and
an arm extending from the base, the arm having an end portion for removably retaining a dispenser of material vertically above a surface;
wherein the end portion and the dispenser are magnetically coupled in a removable retained configuration.

2. The display unit of claim 1, wherein the dispenser is associated with a cap;
wherein the cap includes a first magnetically-sensitive member, and the cap is fixed to a bottom portion of the end portion; and
wherein the dispenser includes a second magnetically-sensitive member which is magnetically coupled and removably attached to the first magnetically-sensitive member.

3. The display unit of claim 2, wherein the second magnetically-sensitive member is composed of a permanent magnet.

4. The display unit of claim 2, wherein the dispenser includes:
a container of the material;
an outlet connected to the container; and
a collar mounted to at least one of the container or the outlet, with the collar including the second magnetically-sensitive member.

5. The display unit of claim 2, wherein the first magnetically-sensitive member is an activatable electromagnet.

6. The display unit of claim 2, wherein the cap is removably fixed to the end portion by a friction-fit.

7. The display unit of claim 2, wherein the cap is removably fixed to the end portion by at least one detent.

8. The display unit of claim 1, wherein the end portion includes a first magnetically-sensitive member; and
wherein the dispenser includes a second magnetically-sensitive member which is magnetically coupled and removably attached to the first magnetically-sensitive member.

9. A display system comprising:
a base; and
a plurality of arms extending from the base, each arm having an end portion for removably retaining a respective dispenser of material vertically above a surface;
wherein each end portion and any associated removably retained dispenser are magnetically coupled in a removable retained configuration.

10. The display system of claim 9, wherein each dispenser is associated with a cap;
wherein each cap includes a first magnetically-sensitive member, and the cap is fixed to a bottom portion of a respective end portion; and
wherein the dispenser includes a second magnetically-sensitive member which is magnetically coupled and removably attached to the first magnetically-sensitive member.

11. The display system of claim 10, wherein the second magnetically-sensitive member is composed of a permanent magnet.

12. The display system of claim 10, wherein each dispenser includes:
a container of the material;
an outlet connected to the container; and
a collar mounted to at least one of the container or the outlet, with the collar including the second magnetically-sensitive member.

13. The display system of claim 10, wherein each cap is removably fixed to its respective end portion by a friction-fit.

14. The display system of claim 10, wherein each cap is removably fixed to its respective end portion by at least one detent.

15. The display system of claim 9, wherein each end portion includes a first magnetically-sensitive member; and
wherein any dispenser associated with a respective end portion includes a second magnetically-sensitive member which is magnetically coupled and removably attached to a respective first magnetically-sensitive member.

16. A method comprising:
extending an arm from a base, the arm having an end portion;
removably retaining, by the end portion, a dispenser of material vertically above a surface; and
wherein the end portion and the dispenser are magnetically coupled in a removable retained configuration.

17. The method of claim 16, further comprising:
fixing a cap to a bottom portion of the end portion; and
associating the dispenser with the cap;
wherein the cap includes a first magnetically-sensitive member; and
wherein the dispenser includes a second magnetically-sensitive member which is magnetically coupled and removably attached to the first magnetically-sensitive member.

18. The method of claim 17, wherein the second magnetically-sensitive member is composed of a permanent magnet.

19. The display unit of claim 17, further comprising:
removably fixing the cap to the end portion by at least one detent.

20. The method of claim 16, wherein the end portion includes a first magnetically-sensitive member; and
wherein the dispenser includes a second magnetically-sensitive member which is magnetically coupled and removably attached to the first magnetically-sensitive member.
